(19) United States
(12) Patent Application Publication
(10) Pub. No.: US 2017/0242151 A1
(43) Pub. Date: Aug. 24, 2017

(54) MID-INFRARED HYDRATE INHIBITOR SENSOR

(71) Applicant: SCHLUMBERGER TECHNOLOGY CORPORATION, Sugar Land, TX (US)

(72) Inventors: Timothy Jones, Cottenham (GB); Nathan Scott Lawrence, Godmanchester (GB); Go Fujisawa, Sagamihara-shi (JP); Sheng Chao, Cambridge (GB); Rolf Rustad, Radal (NO)

(21) Appl. No.: 15/510,249

(22) PCT Filed: Sep. 9, 2015
(86) PCT No.: PCT/US15/49070

§ 371 Date: Mar. 10, 2017

(30) Foreign Application Priority Data
Sep. 15, 2014 (GB) 1416258.0

(51) Int. Cl. G01V 8/14; E21B 49/08

(52) U.S. Cl. CPC G01V 8/14; E21B 49/08; G01N 21/3577

(57) ABSTRACT

A sensor for monitoring a hydrate inhibitor dissolved in a liquid. The sensor includes an internal reflection window for contacting with the liquid. The sensor further includes a mid-infrared light source for directs a beam of mid-infrared radiation into the window to provide for attenuated internal reflection at an interface between the window and the liquid. The internally reflected mid-infrared beam is passed through a narrow bandpass filter which preferentially transmits mid-infrared radiation over a band of wavelengths corresponding to an absorbance peak of the dissolved hydrate inhibitor to filter internally reflected mid-infrared radiation received from the window. The intensity of the reflected mid-infrared beam transmitted through the filter is measured and used to determine an amount of hydrate inhibitor ion the liquid.

Embodiments of the present disclosure relate to mid-infrared sensing, and more particularly but not by way of limitation to a mid-infrared sensor for monitoring hydrate inhibitors.

The analysis of chemical composition of fluid samples from hydrocarbon wells for the determination of phase behaviour and chemical composition is a critical step in the monitoring and management of a hydrocarbon well as well as the evaluation of the producibility and economic value of the hydrocarbon reserves. Similarly, the monitoring of fluid composition during production or other operations can have an important bearing on reservoir management decisions. Similarly, determination of phase behaviour and chemical composition is important in pipelines and the like used to convey/transport hydrocarbons from the wellhead, including subsea pipelines.

Several disclosures have described analysis of specific gases in borehole fluids in the downhole environment using near-infrared (e.g. λ=1−2.5 μm) spectral measurements. For example, U.S. Pat. No. 5,859,430 describes the use of near-infrared spectroscopy to determine quantitatively the presence of methane, ethane and other simple hydrocarbons in the gas phase. The gases were detected using the absorption of near-infrared radiation by the overtone/combination vibrational modes of the molecules in the spectral region 1.64-1.75 μm.

More recently, U.S. Pat. No. 6,995,360 describes the use of mid-infrared radiation with a wavelength λ=3−5 μm to monitor gases in downhole environments, and U.S. Patent Publication No. 2012/0290208 proposes the use of mid-infrared radiation to monitor sequestered carbon dioxide dissolved into the liquid solutions of saline aquifers.

There are however many technical problems with using mid-infrared sensors in the hydrocarbon industry and processing information from such sensors. Additionally, much of the utility of mid-infrared spectroscopy for hydrate inhibitor monitoring has not previously been recognized.

### SUMMARY OF THE INVENTION

Embodiments of the present disclosure are at least partly based on the recognition that hydrate inhibitors used to reduce or prevent formation of gas hydrates at high pressures and low temperatures may be monitored using a sensor based on mid-infrared radiation absorbance.

Accordingly, in a first aspect, an embodiment of the present disclosure provides a sensor for monitoring a hydrate inhibitor dissolved in a liquid, the sensor comprising:
an internal reflection window for contacting with the liquid;
a mid-infrared light source for directing a beam of mid-infrared radiation into said window to provide for attenuated internal reflection at an interface between the window and the liquid;
a first narrow bandpass filter configured to preferentially transmits mid-infrared radiation over a band of wavelengths corresponding to an absorbance peak of the dissolved hydrate inhibitor to filter internally reflected mid-infrared radiation received from the window;
an infrared detector configured to detect filtered mid-infrared radiation transmitted through the first filter; and
a processor arrangement, operably coupled to the infrared detector and configured to measures intensity of the detected mid-infrared radiation transmitted through the first filter and process from the measured intensity an amount (e.g. a concentration) of the hydrate inhibitor dissolved in the liquid.

As discussed below, the sensor may be part of a sensor arrangement with a further similar sensor for obtaining a reference intensity.

In a second aspect, embodiments of the present disclosure provide for the use of the sensor, or sensor arrangement, of the first aspect to determine an amount of a hydrate inhibitor dissolved in a liquid. For example, a method of monitoring a hydrate inhibitor dissolved in a liquid may include: providing the sensor of the first aspect such that the internal reflection window is in direct contact with the liquid; and operating the sensor to determine an amount of the hydrate inhibitor dissolved in the liquid.

In a third aspect, an embodiment of the present disclosure provides a well or pipeline tool including the sensor, or sensor arrangement, of the first aspect. The internal reflection window can be flush with an outer casing of the tool such that the attenuated internal reflection at the interface between the window and the liquid produces an evanescent wave which propagates into the liquid away from the tool. Thus, advantageously, the tool does not require a bypass channel for the sensed liquid.

Optional features of embodiments of the present disclosure will now be set out. These are applicable singly or in any combination with any aspect of the embodiments of the present disclosure.

In embodiments of the present disclosure, the liquid may be, or may be a component of, a production fluid.

By “mid-infrared radiation,” it is meant that in embodiments of the present disclosure the radiation has a wavelength in the range from about 2 to 20 μm, and in some embodiments from about 3 to 12 μm or from about 3 to 10 μm.

In an embodiment of the present disclosure, the first narrow bandpass filter may be configured such that its wavelength transmission band is substantially temperature invariant over all temperatures in the range from −25 to 25° C. Temperatures in subsea environments can vary, e.g. from about −25 to 25° C. By using such a temperature invariant filter, the sensitivity of the sensor to shifts in temperature of its surroundings can be greatly reduced, improving the accuracy with which the amount of the dissolved hydrate inhibitor is determined.

By “substantially temperature invariant,” it is meant herein that the variance in embodiments of the present disclosure is at most about 0.1 nm/° C. In some embodiments, the variance is at most about 0.05, 0.03, 0.02 or 0.01 nm/° C.

In embodiments of the present disclosure, each filter may comprise an interference filter.

Merely by way of example, in some embodiments of the present disclosure, each filter may include a substrate, formed of Si, SiO₂, Al₂O₃, Ge or ZnSe and/or the like, and at each opposing side of the substrate alternating high and low refractive index layers may be formed. In some embodiments of the present disclosure, the high refractive index layers can be formed of PbTe, PbSe or PbS and the low refractive index layers can be formed of ZnS, ZnSe and/or the like.

In embodiments of the present disclosure, each filter may have three or more half wavelength cavities. Many conventional filters display unacceptably high band shifts with increasing temperature. For example, shifts in the range of 0.2 to 0.6 nm/° C. are typical in prior filters. Transmissivities also tend to reduce with increasing temperature. These properties, have prevented/limited development of mid-infrared sensors, especially in the petrochemical industry.

However, in accordance with embodiments of the present disclosure, by using a PbTe-based, a PbSe-based, a PbS-based interference filter and/or the like it is possible to substantially reduce band shifts and transmissivity reductions. For example, a PbTe-based interference filter, in accordance with an embodiment of the present disclosure, may have a band shift of only about 0.03 nm/° C. or less. As an alternative to PbTe, PbSe, PbS or the like, the high refractive index layers can be formed, in some embodiments of the present disclosure, of Ge or the like.

In embodiments of the present disclosure, a reference intensity may be used in the determination of the amount of the hydrate inhibitor in the liquid. Thus a sensor arrangement may include the sensor of the first aspect and a further similar sensor which can be used to obtain this reference intensity. The further sensor can have the same features as the first sensor except that its narrow bandpass filter transmits mid-infrared radiation over a band of wavelengths corresponding to a reference portion of the absorbance spectrum of the liquid. In such a scenario, the processor arrangement can be a shared processor arrangement of both sensors.

Another option, however, is to obtain the reference intensity using the first sensor. For example, the sensor may further include a second narrow bandpass filter transmitting mid-infrared radiation over a band of wavelengths corresponding to a reference portion of the absorbance spectrum of the liquid, the or a further infrared detector detecting filtered mid-infrared radiation transmitted through the second filter, and the processor arrangement measuring the reference intensity of the detected mid-infrared radiation transmitted through the second filter and using the measured reference intensity in the determination of the amount of the hydrate inhibitor in the liquid. The first and second filters may be selectably positionable between a single detector and the window, or each of the first and second filters can have a respective detector. Optional features of the first narrow bandpass filter pertain also to the second narrow bandpass filter.

In embodiments of the present disclosure, the sensor may be able to measure the amounts of more than one hydrate inhibitor dissolved in the liquid. For example, the sensor may include a plurality of the first narrow bandpass filters, each transmitting mid-infrared radiation over a band of wavelengths corresponding to an absorbance peak of a respective hydrate inhibitor, the or a respective further infrared detector detecting the filtered mid-infrared radiation transmitted through each first filter, and the processor arrangement measuring the intensity of the detected mid-infrared radiation transmitted through each first filter and determining therefrom an amount of each hydrate inhibitor dissolved in the liquid. The first filters may be selectably positionable between a single detector and the window, or each first filter can have a respective detector.

When the sensor is able to monitor more than one hydrate inhibitor, the determined amounts of the hydrate inhibitor in the liquid can be in the form of a ratio of the concentrations of the inhibitors.

In embodiments of the present disclosure, the beam of mid-infrared light may be pulsed. This can be achieved, for example, by providing a mechanical chopper between the source and the window, or by pulsing the source.

In embodiments of the present disclosure, the source can be a broad band thermal source or a narrower band source such as a light emitting diode or a laser.

In some embodiments of the present disclosure, the window may comprise a diamond window or a sapphire window. In some embodiments of the present disclosure, the diamond windows can be formed by chemical vapour deposition. Sapphire has a cut off for mid-infrared radiation at wavelengths of about 5 to 6 microns, but sapphire windows can generally be formed more cheaply than diamond windows. Thus, for absorption peaks below the cut off (such as the CO₂ absorption peak at about 4.3 microns), sapphire may be a useful alternative to diamond. In particular, for a given cost a larger window can be formed.

In some embodiments of the present disclosure, the sensor may further include a heater which is operable to locally heat the window, thereby cleaning the surface of the window in contact with the fluid. For example, in some embodiments of the present disclosure, if the window includes a conductive or semiconductive material (e.g. an area of semiconductive boron-doped diamond), the heater may comprise an electrical power supply that may send a current through the window to induce resistive heating thereof For example, in some embodiments of the present disclosure, a diamond window can have a central mid-infrared transmissive (e.g. undoped) area and an encircling area of semiconductive boron-doped diamond. The heater can induce resistive heating of the encircling area, and the central area can then be heated by conduction of heat from the encircling area. In some embodiments of the present disclosure, the heater may heat the window to a peak temperature of at least about 400° C. In some embodiments of the present disclosure, the heater may maintain a peak temperature for less than one microsecond.

Alternatively or additionally, in some embodiments of the present disclosure, the sensor may further include an ultrasonic cleaner which is operable to ultrasonically clean the surface of the window in contact with the fluid. As another option, the sensor may be provided with a pressure pulse arrangement which is operable to produce a pressure pulse in the fluid at the window, thereby cleaning the surface of the window in contact with the fluid. In some embodiments of the present disclosure, the arrangement may produce a pressure pulse of at least about 1000 psi (6.9 MPa) in the fluid.

In an embodiment of the present disclosure, the sensor may be located subsea, e.g. on a subsea pipeline.

The inhibitor may be a thermodynamic inhibitor such as methanol, ethanol, monoethylene glycol or diethylene glycol, or it may be a kinetic inhibitor such as polyvinylpyrrolidone or polyvinylcaprolactam. In embodiments of the present disclosure, the positions and heights of the mid-infrared absorbance peak(s) of such compounds tend to be insensitive to salt content in the (typically water-based) liquid. Thus, in embodiments of the present disclosure, the sensitivity of the determination of the amount of the inhibitor to salt concentration is reduced. In an embodiment of the present disclosure, the first narrow bandpass filter may preferentially transmit mid-infrared radiation over a band of wavelengths corresponding to a 1040 cm⁻¹ or a 1084 cm⁻¹ absorbance peak for monoethylene glycol, a 1020 cm⁻¹ absorbance peak for methanol, a 1045 cm⁻¹ absorbance peak for ethanol, a 1085 cm⁻¹ absorbance peak for ethanol, or a 1295 cm⁻¹ absorbance peak for polyvinylpyrrolidone.

In embodiments of the present disclosure, the monitored hydrate inhibitor can be:
one or more compounds or ions dissolved in the liquid, or
a constituent group of a compound or ion dissolved in the liquid, or a constituent group common to one or more compounds or ions dissolved in the liquid.

### BRIEF DESCRIPTION OF THE DRAWINGS

Embodiments of the invention will now be described by way of example with reference to the accompanying drawings in which:

FIG. 1 shows schematically, in accordance with embodiments of the present disclosure, (a) a mid-infrared sensor, and (b) the sensor implemented as a module in a toolstring/pipeline monitoring system;

FIG. 2 shows schematically a narrow bandpass filter, in accordance with an embodiment of the present disclosure, based on Fabry-Perot interferometry;

FIG. 3 shows variation of dλₘ/λₘdT for a suite of filters fabricated with ZnSe as the low refractive index material and PbTe as the high refractive index material;

FIG. 4 shows plots of transmissivity against wavelength at a range of temperatures from 25 to 200° C. for (a) a PbTe-based filter having a pass band centred at 4.26 μm, and (b) a PbTe-based filter having a pass band centred at 12.1 μm;

FIG. 5 shows (a) a reference intensity spectrum 1₀ obtained from a fluid not containing a given species, (b) an intensity spectrum I obtained from the fluid containing the species, and (c) the absorbance spectrum of the species;

FIG. 6 shows intensity spectra obtained for dodecane dissolved in deuterated chloroform for increasing concentrations of dodecane, the spectra being superimposed with transmissivity plots for a first filter having a pass band of 3000 to 2800 cm⁻¹, and a second filter having a pass band of 2000 to 1800 cm⁻¹;

FIG. 7 shows a plot of modified absorbance A′ against hydrocarbon content for dodecane dissolved in deuterated chloroform;

FIG. 8 shows a plot of absorbance against dissolved CO₂ concentration in water or hydrocarbon;

FIG. 9 shows mid-infrared absorbance spectra of (a) monoethylene glycol in water, (b) methanol in water, and (c) ethanol in water, for different inhibitor concentrations from 0 to 100 vol %;

FIG. 10 shows plots of absorbance against inhibitor concentration for (a) monoethylene glycol in water, (b) methanol in water, and (c) ethanol in water;

FIG. 11 shows mid-infrared absorbance spectra of (a) 50 vol % monoethylene glycol in water and in water saturated with NaCl, (b) 50 vol % methanol in water and in water saturated with NaCl, and (c) 50 vol % ethanol in water and in water saturated with NaCl;

FIG. 12 shows shows mid-infrared absorbance spectra at 50 vol % water of mixtures of monoethylene glycol and methanol, with the mixtures varying from 100% monoethylene glycol to 100% methanol;

FIG. 13 shows plots of absorbance against concentration for respectively monoethylene glycol (diamonds) based on the leftmost peak of FIG. 12 and methanol (squares) based on the rightmost peak of FIG. 12;

FIG. 14 shows mid-infrared absorbance spectra of polyvinylpyrrolidone in water, for different inhibitor concentrations from 0 to 5 wt %;

FIG. 15 shows a plot of absorbance against inhibitor concentration for polyvinylpyrrolidone in water; and

FIG. 16 shows mid-infrared absorbance spectra of 5 wt % polyvinylpyrrolidone in water and in water saturated with NaCl.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention, it being understood that various changes may be made in the function and arrangement of elements without departing from the scope of the invention.

Specific details are given in the following description to provide a thorough understanding of the embodiments. However, it will be understood by one of ordinary skill in the art that embodiments maybe practiced without these specific details. For example, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

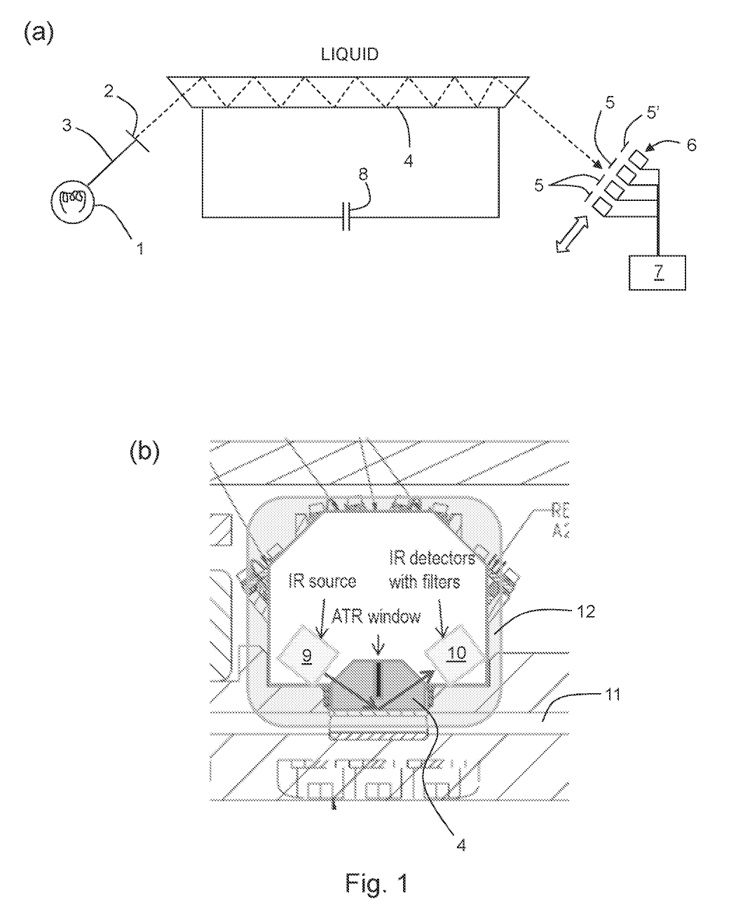

FIG. 1(a) shows schematically a mid-infrared sensor, in accordance with an embodiments of the present disclosure, having a thermal broad band mid-infrared source 1, a mechanical chopper 2 that pulses a beam 3 of mid-infrared radiation which issues from the source, a diamond window 4, a set of selectively movable first narrow bandpass filters 5 and a second narrow bandpass filter 5′, respective mid-infrared detectors 6 for the filters, and a processor arrangement 7. The sensor is encased in a protective housing which allows the sensor to be deployed downhole, the window 4 being positioned for contact with the liquid to be monitored. Mid-infrared waveguides (not shown) optically connect the source, window and the detectors. Suitable waveguides can be formed from optical fibres (e.g. hollow fibres or chalcogenide fibres), solid light pipes (e.g. sapphire pipes), or hollow light pipes (e.g. air or vacuum filled) with a reflective (e.g. gold) coating.

As the detector 6 changes its output with its temperature, even small changes in temperature can cause a large drift in signal output. However, pulsing the beam 3 allows the output signal of the detector to be frequency modulated, enabling removal of the environmental temperature effects from the signal. More particularly, the environment effects can be largely removed electronically by a high pass filter, because the time constant for environment effects tends to be much longer than the signal frequency. Typically, the detector output is AC-coupled to an amplifier. The desired signal can then be extracted e.g. electronically by lock-in amplification or computationally by Fourier transformation.

Instead of the thermal source 1 and the mechanical chopper 2, the pulsed beam 3 may be produced e.g. by a pulsable thermal source, light emitting diode or laser source. Pulsing the source in this way can give the same benefit of frequency modulation measurement, plus it can reduce resistive heating effects.

The beam 3 enters at one edge of the window 4, and undergoes a number of total internal reflections before emerging from the opposite edge. The total internal reflection of the infrared radiation at the liquid side of the window is accompanied by the propagation of an evanescent wave into the liquid. As the liquid preferentially absorbs certain wavelengths, depending on its chemical composition, this causes the emerging beam to have a characteristic variation in intensity with wavelength.

In some embodiments of the present disclosure, a window 4 is mechanically able to withstand the high pressures and temperatures typically encountered downhole and subsea. In embodiments of the present disclosure, the window is chemically stable to fluids encountered downhole and subsea and is transparent in the mid-IR wavelength region. In embodiments of the present disclosure, the window may comprise diamond, sapphire and/or the like.

In an embodiment of the present disclosure, the first narrow bandpass filters 5 each transmit mid-infrared radiation over a band of wavelengths corresponding to an absorbance peak of a respective hydrate inhibitor in the liquid, while the second narrow bandpass filter 5′ transmits mid-infrared radiation over a band of wavelengths corresponding to a reference portion of the absorbance spectrum of the liquid. The beam 3 then passes through a selected one of the narrow bandpass filters and is detected at the respective detector 6. Instead of having a plurality of detectors, each movable with its corresponding filter (as indicated by the double-headed arrow), a further option is to have a single detector in front of which the filters are selectively movable.

The detector 6 may comprise semiconductor photo-diodes (particularly in subsea applications), thermopiles or pyroelectric detectors.

In an embodiment of the present disclosure, the processor arrangement 7 receives a signal from the respective detector 6, which it processes to measure the intensity of the detected mid-infrared radiation transmitted through each filter 5, 5′, and, as discussed in more detail below, determines therefrom an amount of the respective hydrate inhibitor in the liquid.

Also discussed in more detail below, the sensor may include a heater 8 which is operable to locally heat the window 4, thereby cleaning the surface of the window in contact with the liquid. Other options, however, are to clean the window ultrasonically (as described for example in U.S. Pat. No. 7,804,598), or with a mechanical wiper.

FIG. 1(b) shows schematically, in accordance with an embodiment of the present disclosure, how the sensor may be implemented as a module in a toolstring/pipeline monitoring system. The source 1 and chopper 2 are contained in a source unit 9 and filters 5, 5′ and detectors 6 are contained in a detector unit 10. These are located close to the window 4 that may be in contact with a tool flowline 11. In the pipeline monitoring system the window may be disposed in a wall of the pipe or a wall of section of the pipe configured for pipeline monitoring. The sensor may be packaged in a protective metal chassis 12 to withstand the high pressure of the fluid in the flowline. In the subsea system, the package may be coupled with or integrated into the pipeline being monitored. The window is sealed into the chassis/pipeline to withstand the high pressures, and its packaging ensures no direct source light strays into the detectors.

### Narrow Bandpass Filters

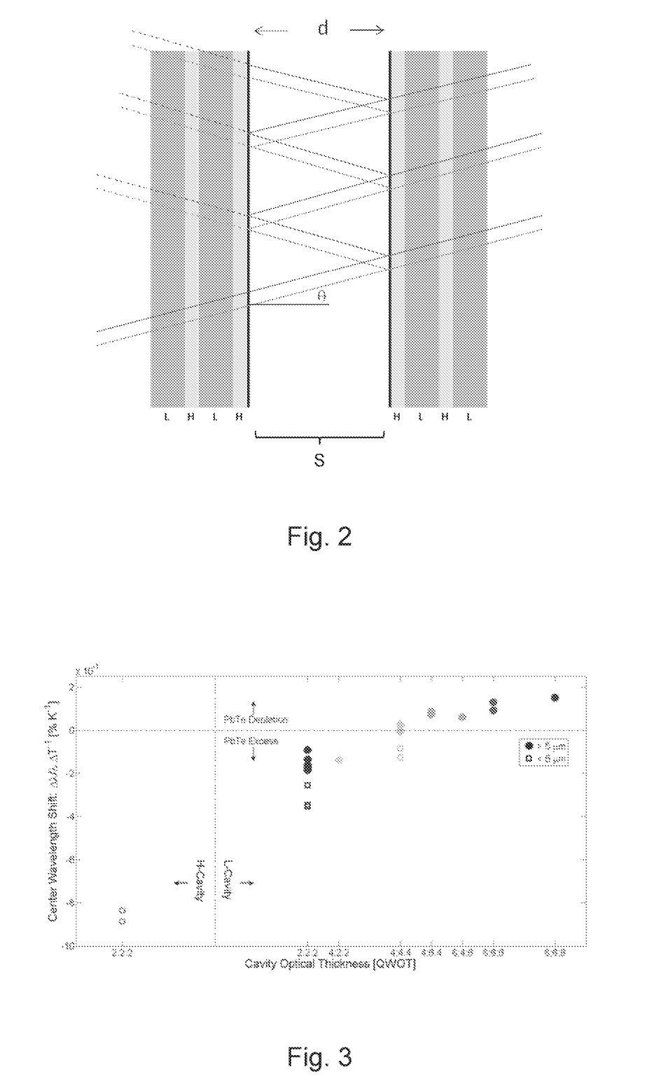

In embodiments of the present disclosure, the narrow bandpass filters 5, 5′ may be based on Fabry-Perot interferometry. As shown in FIG. 2, each filter may have a substrate S of low refractive index and thickness d. On opposing surfaces of the substrate are stacked alternating high-reflectivity dielectric layers of high H and low L refractive index deposited onto the substrate using techniques such as ion-beam sputtering or radical-assisted sputtering. In some embodiments of the present disclosure, each layer in the stacks of alternating layers of high H and low L refractive index has an optical thickness of a quarter wavelength.

The optical thickness ndcosθ of the substrate S, where n is the refractive index of the substrate, is equal to an integer number of half wavelengths λₘ, where λₘ is the peak transmission wavelength, corresponding approximately to the centre wavelength of the pass band of the filter. The condition for the transmission of radiation of wavelength λₘ through the filter is thus mλₘ/2=ndcosθ, where m is an integer.

The spectral region of conventional narrow bandpass dielectric filters designed to operate in the mid-infrared spectral regions shifts systematically to longer wavelengths with increasing temperature. The origin of the change in λₘ with temperature is a change in the material properties with temperature of the dielecric materials that comprise the layers of the filter.

However, an approach described below, in accordance with an embodiment of the present disclosure, provides for the configuration and fabrication of mid-infrared narrow bandpass filters that have substantially temperature invariant optical properties over a wide temperature range.

The approach can be considered by the design of the filter:

(LH)^{x1}(LL)^{y1}(HL)^{x2}(LL)^{y2} . . . (LL)^{yN}(HL)^{xN+1}

consisting of a total of y half wavelength spacers (cavities) LL of low refractive index material in N cycles (y=Σyᵢ), LH being the stacks of xᵢ quarter wavelength layers of alternating of high and low refractive index material in the N cycles. The reflections wavelength of the quarter wavelength reflector stack (which is the only reflection to undergo constructive interference), irrespective of the values of x, and N, can be expressed as:

λₘ=2(n_{L}d_{L}+n_{H}d_{H})

for first order reflections (m=0). The temperature variation of the wavelength in the reflector stack dλₘ/dT|ₛ can be expressed as:

$$\frac{d {λ}_{m}}{dT} {\vert}_{s} = 2 {n}_{L} {d}_{L} ( {C}_{L} + \frac{{dn}_{L}}{{n}_{L} dT} ) + 2 {n}_{H} {d}_{H} ( {C}_{H} + \frac{{dn}_{H}}{{n}_{H} dT} )$$

where C_{L} and C_{H} are the coefficients of linear expansion of the low and high refractive index materials, respectively. From eqn.[1] for first order reflection and normal incidence (i.e., m=1 and θ=0° , the corresponding temperature dependence dλₘ/dT|_{c} of the cavity layer of low refractive index material is given by:

$$\frac{d {λ}_{m}}{dT} {\vert}_{c} = 2 {yn}_{L} {d}_{L} ( {C}_{L} + \frac{{dn}_{L}}{{n}_{L} dT} )$$

noting that y is the total number of half wavelength cavity layers. The total change in wavelength with temperature d□ₘ/dT|_{T} is given by the sum of dλₘ/dT|_{c} and dλₘ/dT|ₛ:

$$\frac{d {λ}_{m}}{dT} {\vert}_{T} = 2 ( 1 + y ) {n}_{L} {d}_{L} ( {C}_{L} + \frac{{dn}_{L}}{{n}_{L} dT} ) + 2 {n}_{H} {d}_{H} ( {C}_{H} + \frac{{dn}_{H}}{{n}_{H} dT} )$$

$$or$$

$$\frac{d {λ}_{m}}{{λ}_{m} dT} {\vert}_{T} = ( 1 + y ) ( {C}_{L} + \frac{{dn}_{L}}{{n}_{L} dT} ) + ( {C}_{H} + \frac{{dn}_{H}}{{n}_{H} dT} )$$

noting that n_{L}d_{L}=n_{H}d_{H} at the temperature for which the filter is designed for use. Clearly dλₘ/dT|_{T} can only be zero if the value of dn/dT for one of the materials is negative. This condition can be fulfilled by high refractive index materials such as PbTe, PbSe or PbS. For close matching of the value of dλₘ/dT|_{T} to zero, the wavelength dependence of n, temperature and wavelength dependence of dnᵢ/dT can be taken into account.

The condition dλₘ/dT|_{T}=0 is given approximately by:

$$\frac{{dn}_{H}}{{n}_{H} dT} = - ( 1 + y ) \frac{{dn}_{L}}{{n}_{L} dT}$$

noting that C, is considerably smaller than dnᵢ/nᵢdT for most materials used in mid-infrared filters. The term (1+y) can be chosen to satisfy the above expression depending on the choice of low refractive index material. For example, with ZnSe and PbTe for the low and high refractive index materials, respectively, and using the material values of bulk phases n_{L}=2.43, n_{H}=6.10, dn_{L}/dT=6.3×10⁻⁵ K⁻¹ and dn_{H}/dT=−2.1×10⁻³ K⁻¹ for λₘ=3.4 □m, the expression is satisfied with y=13.3, i.e., approximately 13 half wavelength cavity layers are required to achieve the condition dλₘ/dT|_{T}=0.

There is considerable variation in the values of the material properties (n_{H}, dn_{H}/dT, C_{H}, etc.) that appear in for thin films in a multilayer structure and therefore in the predicted value of dλₘ/λₘdT or the value of y required to achieve the condition dλₘ/λₘdT=0. The uncertainty is particularly severe for the value of dn_{H}/dT for PbTe in view of its magnitude and influence on the value of y. For example, the value of dn/dT for PbTe at λₘ=5 □m has been reported to be −1.5×10⁻³ K⁻¹ by Zemel, J. N., Jensen, J. D. and Schoolar, R. B., “ELECTRICAL AND OPTICAL PROPERTIES OF EPITAXIAL FILMS OF PBS, PBSE, PBTE AND SNTE”, Phys. Rev. 140, A330-A343 (1965), −2.7×10⁻³ K⁻¹ by Piccioli, N., Besson, J. M. and Balkanski, M., “OPTICAL CONSTANTS AND BAND GAP OF PBTE FROM THIN FILM STUDIES BETWEEN 25 AND 300° K”, J. Phys. Chem. Solids, 35, 971-977 (1974), and −2.8×10⁻³K⁻¹ by Weiting, F. and Yixun, Y., “TEMPERATURE EFFECTS ON THE REFRACTIVE INDEX OF LEAD TELLURIDE AND ZINC SELENIDE”, Infrared Phys., 30, 371-373 (1990). From the above expression, the corresponding values of y (to the nearest integer) are 9, 17 and 18, respectively.

In view of the uncertainties in the value of dn/dT for PbTe and therefore the number of low refractive index half wavelength spacers required to achieve dλₘ/dT=0, a more useful approach is to determine the experimental value of dλₘ/dT as a function of the optical thickness of the low refractive index cavities for a suite of filters fabricated by the same method. FIG. 3 shows the variation of dλₘ/λₘdT for a suite of filters fabricated with ZnSe as the low refractive index material and PbTe as the high refractive index material. The plot shows that a particular value of dλₘ/λₘdT can be achieved by controlling the ratio of low to high refractive index materials in the filter (i.e., a parameter similar to y in the above expression). FIG. 3 shows that for λₘ<5 μm, the condition dλₘ/λₘdT=0 is met by a 4:4:4 (i.e., 3 full wavelength or 6 half wavelength cavities (y=6)) filter, while for λₘ>5 □m a 6:4:6 (y=8) filter is required.

The approach illustrated by FIG. 3 can be used, in accordance with an embodiment of the present disclosure, to fabricate substantially temperature invariant filters over the entire mid-infrared spectral range. In some embodiments of the present disclosure, the substrate may be formed of Si, SiO₂, Al₂O₃, Ge or ZnSe In some embodiments of the present disclosure, high refractive index layers can be formed of PbTe, PbSe or PbS, although Ge is also an option. In some embodiments of the present disclosure, the low refractive index layers can be formed of ZnS or ZnSe

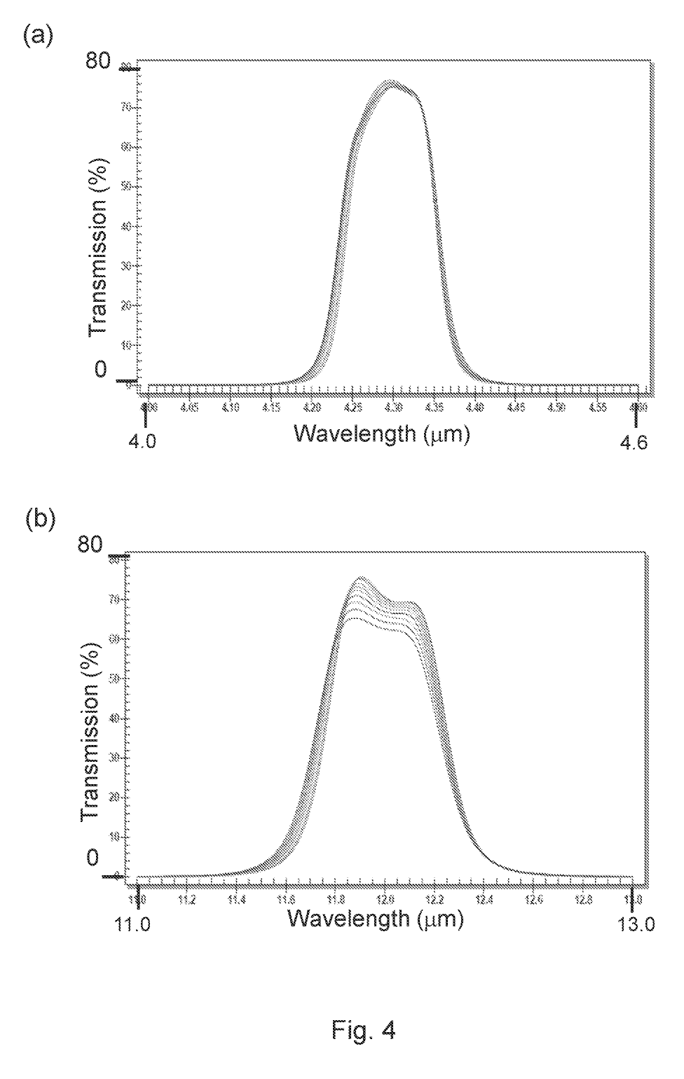

FIG. 4 shows plots of transmissivity against wavelength at a range of temperatures from 25 to 200° C. for (a) a PbTe-based filter having a pass band centred at 4.26 μm with optimum optical matching to the substrate and 3 full wavelength thickness cavities (4:4:4), and (b) a degenerate PbTe-based filter having a pass band centred at 12.1 μm with 3 half wavelength cavities (2:2:2). Similar filters can be produced having pass bands centred at other mid-infrared wavelengths. The value of dλₘ/dT for the λₘ=4.26 □m (4:4:4) filter varies from −0.04 nm/K at 20° C. to +0.03 nm/K at 200° C. and is essentially zero over the temperature range 80-160° C. The value of dλₘ/dT for the λₘ=12.1 □m (2:2:2) filter is −0.21 nm/K, over the temperature range 20-200° C. This allows such filters to deployed downhole or in subsea locations, where temperatures may vary from about 25 to 200° C., without the pass band of the filter shifting to such an extent that it no longer corresponds to the absorbance peak of its respective species. Similarly, filters can be configured for use in subsea locations, where temperatures can vary from about −25 to 25° C., without significant pass band shifting.

### Spectroscopy

The Beer-Lambert law applied to the sensor of FIG. 1 provides that:

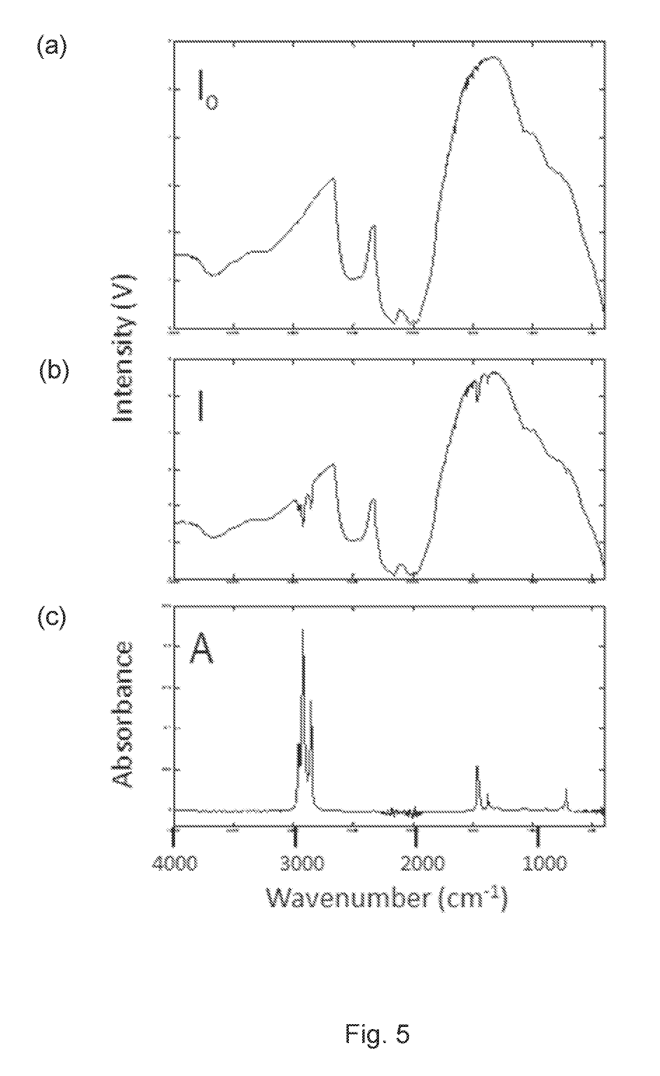

A=−log₁₀(I/I₀)

where A is the absorbance spectrum by a species in a fluid having an absorbance peak at a wavelengths corresponding to the pass band of the filter 5, I is the intensity spectrum of the infrared radiation detected by the detector 6, and I₀ is a reference intensity spectrum. For example, FIG. 5 shows (a) a reference intensity spectrum I₀ obtained from a fluid not containing a given species, (b) an intensity spectrum I obtained from the fluid containing the species, and (c) the absorbance spectrum of the species.

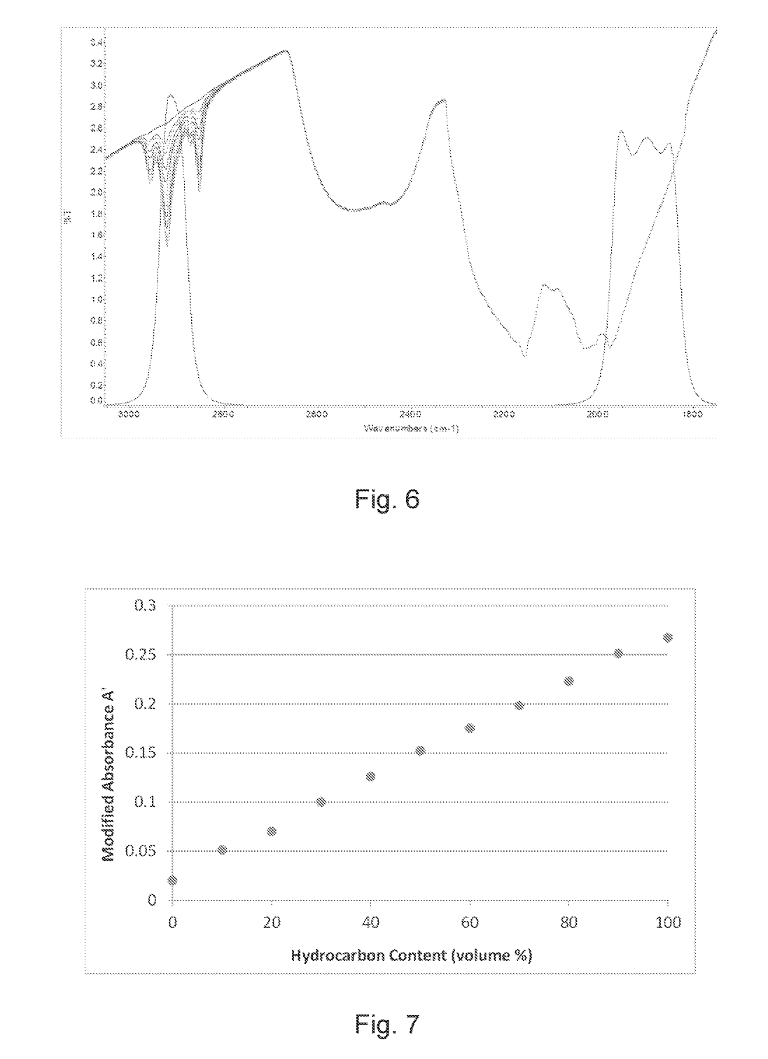

FIG. 6 shows intensity spectra obtained for dodecane dissolved in deuterated chloroform for increasing concentrations of dodecane. With increasing hydrocarbon content there is increased absorption in a first wavenumber range of 3000 to 2800 cm⁻¹. Conversely, the increasing hydrocarbon content has substantially no effect on absorption in a second wavenumber range of 2000 to 1800 cm⁻¹. The second range can thus be used as the reference to the first range. Superimposed on FIG. 6 are transmissivity plots for a first filter having a pass band of 3000 to 2800 cm⁻¹, and a second filter having a pass band of 2000 to 1800 cm⁻¹. Two spectra are thus, in effect, detected by the filters, the first spectrum being the unfiltered spectrum multiplied by the transmissivity of the first filter and the second sub-spectrum being the unfiltered spectrum multiplied by the transmissivity of the second filter. The pass band areas of the spectra (as determined by the strengths of the signals received by the photodiode detectors), correspond to respective intensity measurements BA and BA₀. These are thus used to calculate a modified absorbance A′ for dodecane dissolved in deuterated chloroform which is In(BA/BA₀).

FIG. 7 shows a plot of modified absorbance A′ against hydrocarbon content for dodecane dissolved in deuterated chloroform. The plot exhibits an approximately linear relationship between A′ and hydrocarbon content.

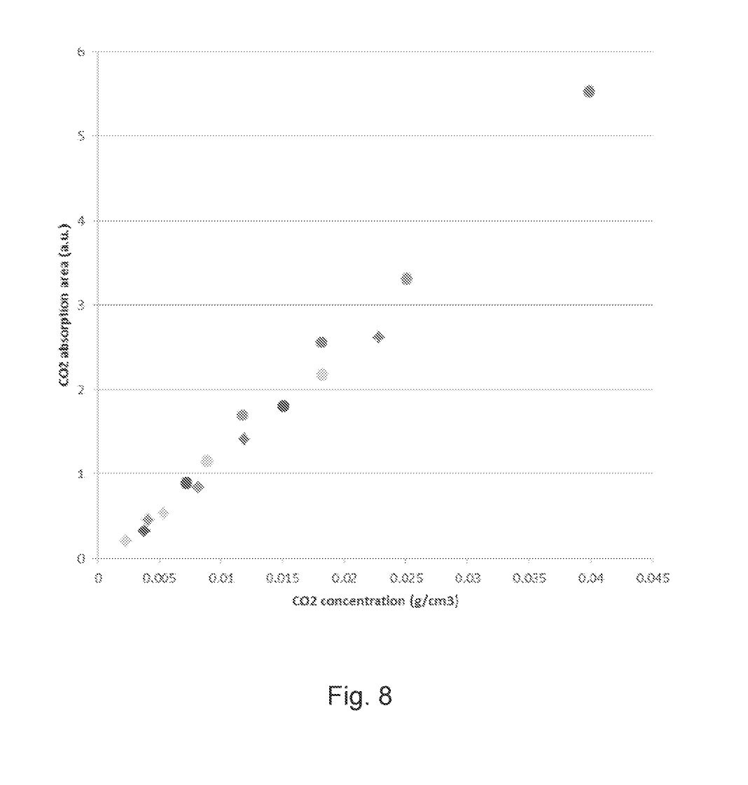

Other species can be monitored in this way. For example, FIG. 8 shows a plot of absorbance against dissolved CO₂ concentration in water or hydrocarbon under the high partial pressures and temperatures typical of oil field wellbore conditions.

### Hydrate Inhibitor Concentration

A mid-infrared sensor, of the type discussed above, may, in accordance with embodiments of the present disclosure, be used to monitor hydrate inhibitor concentrations, for example in subsea locations, such as subsea pipelines.

In the subsea environemnt, gas hydrates can form, particularly, in production pipelines. This is undesirable as the hydrates can agglomerate and block the flow in the pipeline and/or cause equipment damage. Two solutions are generally proposed. One is to add thermodynamic inhibitors, such as methanol, ethanol, monoethylene glycol or diethylene glycol, to the flow. These compounds may be recovered and recirculated. Although such thermodynamic inhibitors are cheap, they usually have to be added in large quantities in order to have a thermodynamic effect of lowering the hydrate formation temperature and/or delaying hydrate formation. The second is to add kinetic inhibitors, such as polyvinylpyrrolidone or polyvinylcaprolactam, to the flow. These work by slowing down the rate of hydrate nucleation and/or reducing hydrate agglomeration. The kinetic inhibitors can be effective in lower doses, but are more expensive than most thermodynamic inhibitors.

With both types of inhibitor, it is important to be able to measure the concentration of inhibitor in the liquid. In the subsea environment, salt can be present in the liquid, sometimes in varying amounts. However, in a mid-infrared sensor, in accordance with embodiments of the present disclosure, the positions of mid-infrared absorption peaks of many inhibitors are not sensitive to salt concentration. As such, a mid-infrared sensor, in accordance with an embodiment of the present disclosure, provides for measuring inhibitor concentration in fluids with varying salt concentrations.

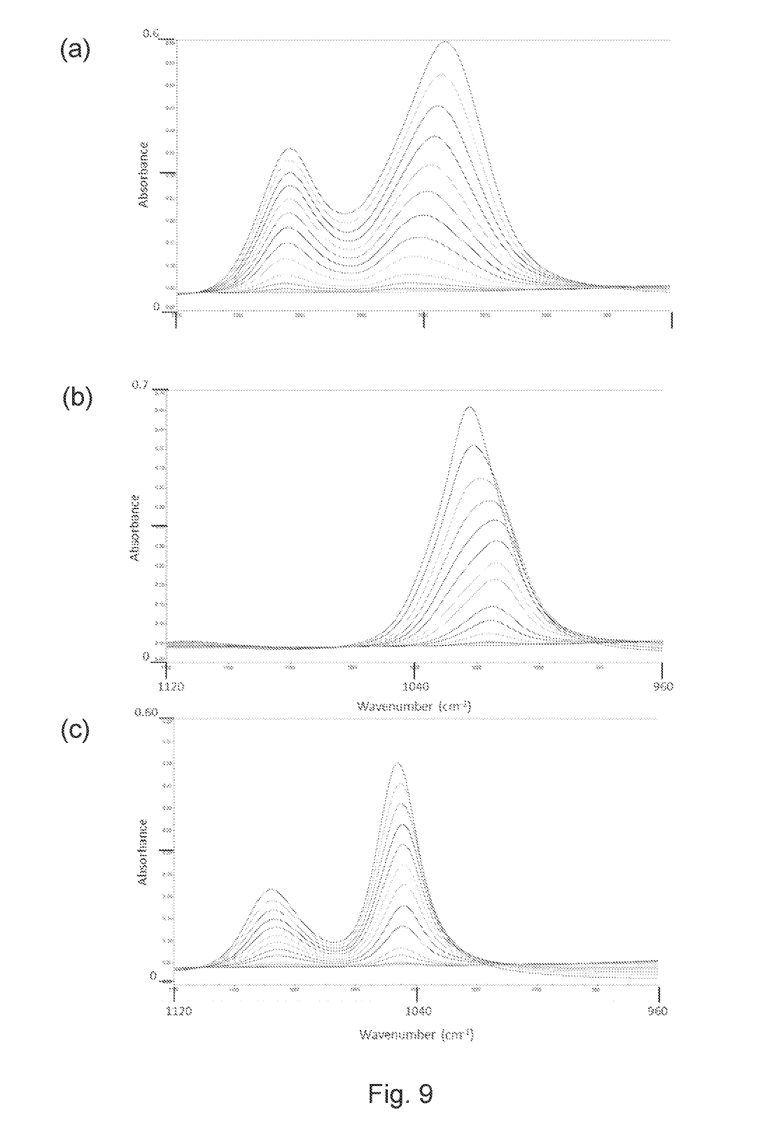

FIG. 9 shows mid-infrared absorbance spectra of (a) monoethylene glycol in water, (b) methanol in water, and (c) ethanol in water, for different inhibitor concentrations from 0 to 100 vol %.

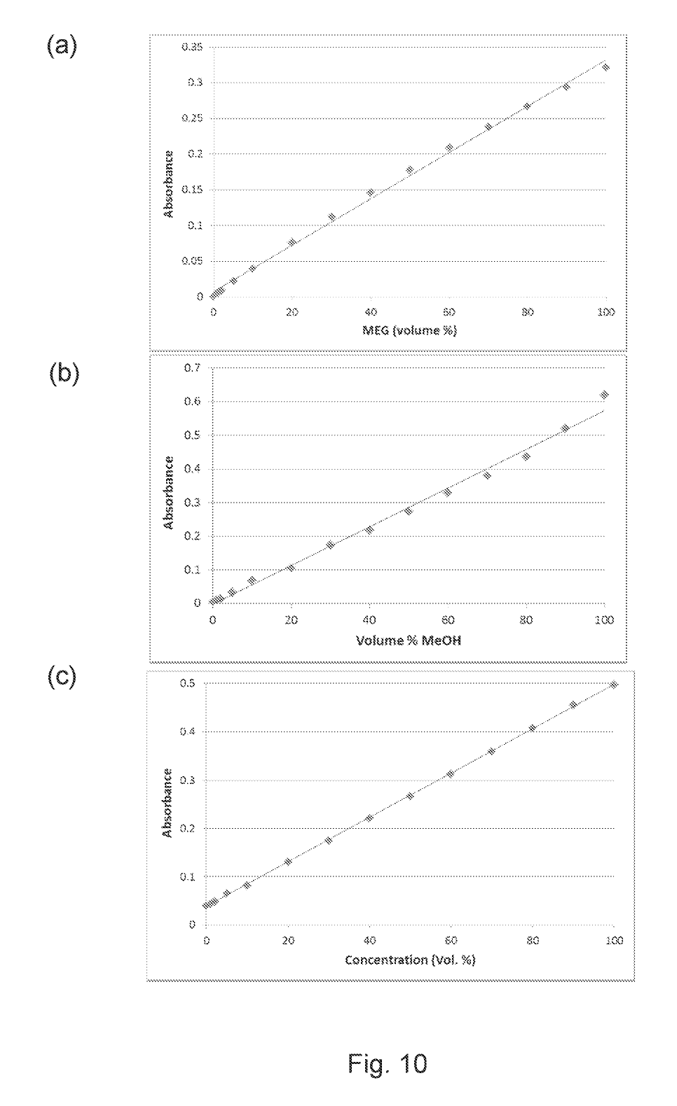

FIG. 10 shows plots of absorbance against inhibitor concentration for (a) monoethylene glycol in water, (b) methanol in water, and (c) ethanol in water. For FIG. 10(a), the absorbances were measured using a band located on the 1084 cm⁻¹ absorbance peak and a band corresponding to a reference portion of the absorbance spectrum. For FIG. 10(b), the absorbances were measured using a band located on the 1020 cm⁻¹ absorbance peak and a band corresponding to a reference portion of the absorbance spectrum. For FIG. 10(c), the absorbances were measured using a band located on the 1045 cm⁻¹ absorbance peak and a band corresponding to a reference portion of the absorbance spectrum. The plots of FIGS. 10(a) to (c) demonstrate good linearity between absorbance and concentration.

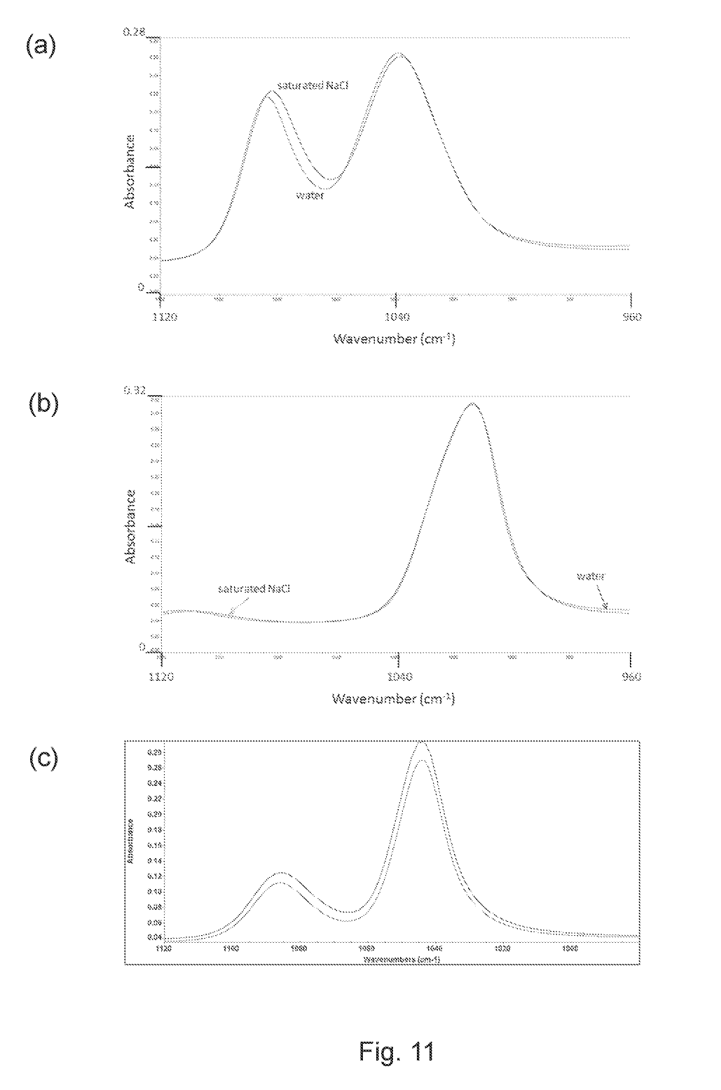

FIG. 11 shows mid-infrared absorbance spectra of (a) 50 vol % monoethylene glycol in water and in water saturated with NaCl, (b) 50 vol % methanol in water and in water saturated with NaCl, and (c) 50 vol % ethanol in water and in water saturated with NaCl. For monoethylene glycol, the 1084 cm⁻¹ absorbance peak shifts in the presence of NaCl, but the position of an alternative 1040 cm⁻¹ absorbance peak is static. This illustrates how a mid-infrared sensor in accordance with the present disclosure may be used to measure species, such as monoethylene glycol in the presence of NaCl. in particular, the mid-infrared sensor can be tuned, i.e., the filter can be tuned, to account for absorbance peak shifts in the presence of NaCl. For methanol, the position of the 1020 cm⁻¹ absorbance peak is static, and for ethanol the position of the 1044 cm⁻¹ absorbance peak is static. Similarly.

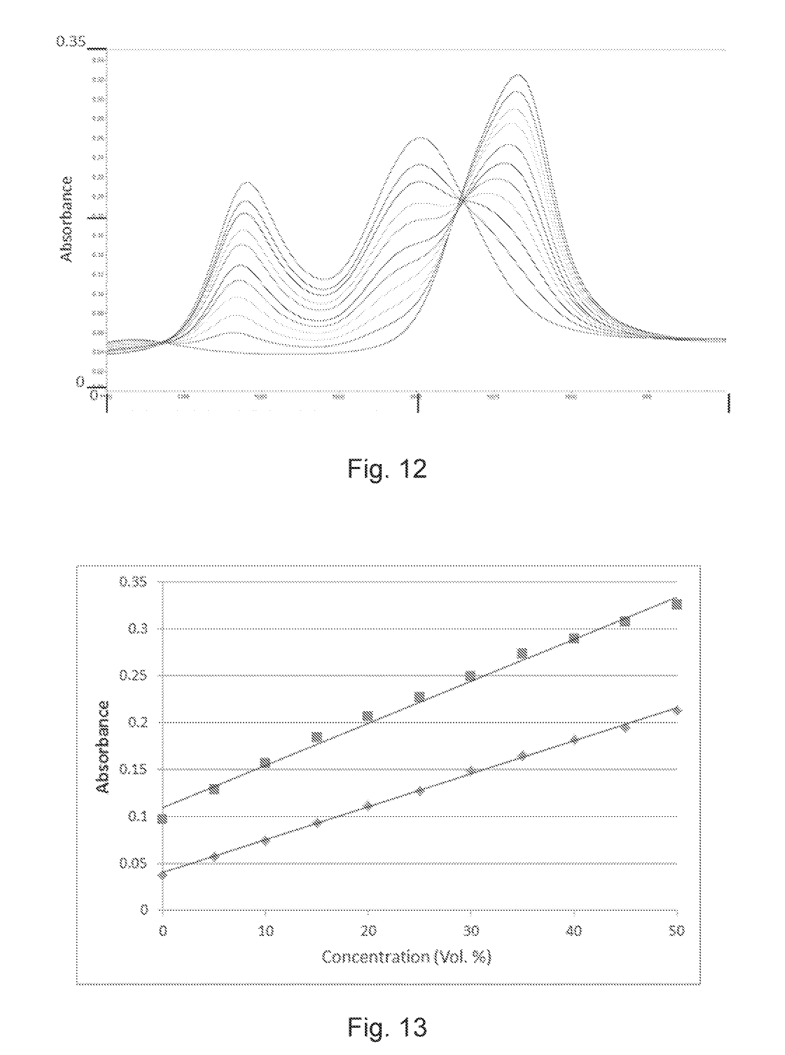

FIG. 12 shows mid-infrared absorbance spectra at 50 vol % water of mixtures of monoethylene glycol and methanol, with the mixtures varying from 100% monoethylene glycol to 100% methanol. The right hand peak grows with increasing methanol, and the two left hand peaks grow with increasing monoethylene glycol. FIG. 13 shows plots of absorbance against concentration for respectively monoethylene glycol (diamonds) based on the leftmost peak and methanol (squares) based on the rightmost peak. In accordance with embodiments of the present disclosure, relative amounts of monoethylene glycol and methanol in a mixture can be determined from such plots.

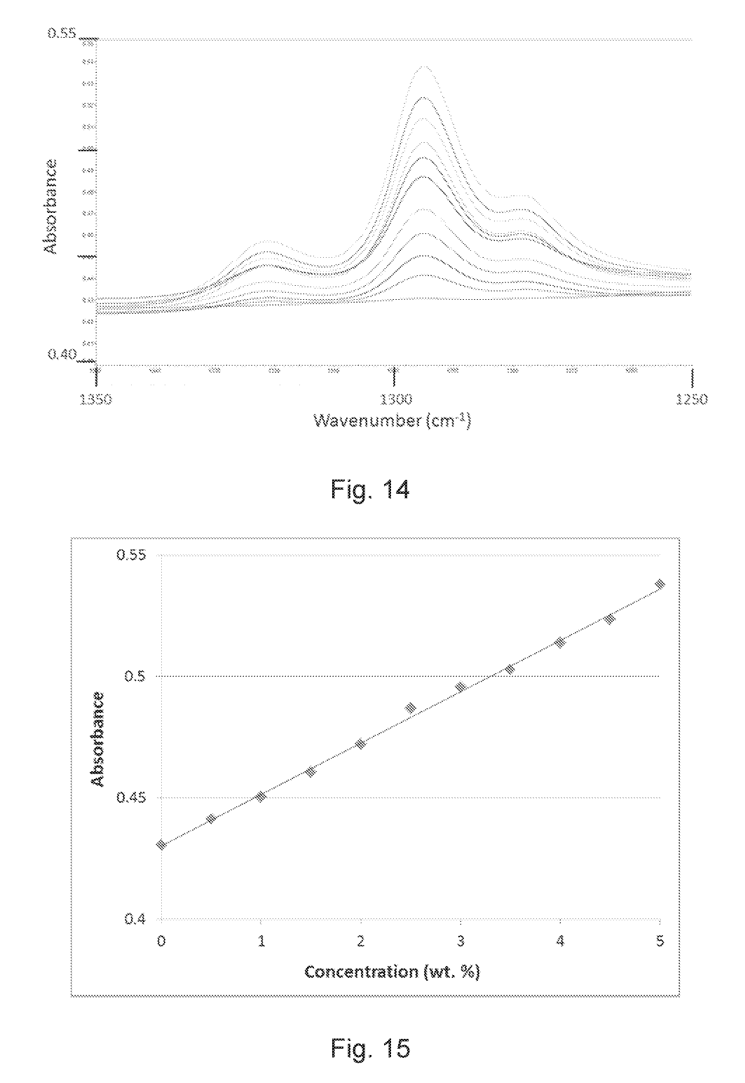

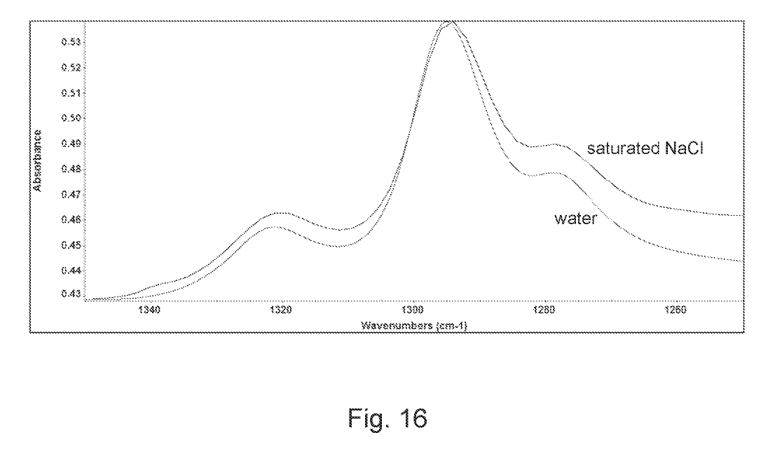

FIG. 14 shows mid-infrared absorbance spectra of polyvinylpyrrolidone in water, for different inhibitor concentrations from 0 to 5 wt %, and FIG. 15 shows a plot of absorbance against inhibitor concentration for polyvinylpyrrolidone in water, using a band located on the 1295 cm⁻¹ absorbance peak and a band corresponding to a reference portion of the absorbance spectrum. The plot of FIG. 15 demonstrates good linearity between absorbance and concentration. FIG. 16 shows mid-infrared absorbance spectra of 5 wt % polyvinylpyrrolidone in water and in water saturated with NaCl, the position of the 1295 cm⁻¹ absorbance peak being static. Thus as with the other species, such an inhibitor can be measured in the presence of salt as absorption can be differentiated and/or the sensor can be tuned for movement of the peaks in the presence of salt.

As mentioned above, the sensor of FIG. 1 may, in some embodiments of the present disclosure, comprise a heater 8 that is operable to locally heat the window 4, thereby cleaning the surface of the window in contact with the fluid.

Cleaning the window in this manner may be particularly effective, compared to other techniques such as ultrasonic cleaning or mechanical wiper cleaning.

The window 4 can be formed, for example, in some embodiments of the present disclosure, of diamond (e.g. by chemical vapour deposition). A central (typically undoped) area of the window may be mid-infrared transmissive, while an annular encircling area of the window may be made semiconductive, e.g. by boron doping that part of the window. The heater 8 can then be a simple electrical power source which sends a current through the window to induce resistive heating of the encircling area. The central area of the window is then heated by thermal conduction from the encircling area. Boron-doping of diamond components is discussed in U.S. Pat. No. 7,407,566.

In some embodiments of the present disclosure, the heater 8 may be able to heat the window to at least 400° C. This is higher than the 374° C. super-critical point for water, where super-critical water comprises a good cleaner and oxidiser. In some embodiments of the present disclosure, it is unnecessary to keep the window at high temperature for a long time period. In particular, less than a microsecond at peak temperature may be enough for cleaning purposes, with longer periods requiring more power and increasing the risk of overheating of other parts of the sensor.

### Pressure Pulse Cleaner

In addition, or as an alternative, to the above heater, cleaning of the window 4 may, in some embodiments of the present disclosure, be performed by providing the sensor with a pressure pulse arrangement. For example, the sensor may be located on a fluid flow line between a pump for the fluid and an exit port from the flow line. With the exit port in a closed position, the fluid pressure can be increased in front of the window to above hydrostatic pressure by the pump. Subsequent of opening the exit port creates a sudden pressure difference that flushes the flowline fluid, e.g. to the borehole. The sudden movement of dense fluid in front of the window dislodges and carries away window contamination. A 1000 psi (6.9 MPa) pressure pulse is generally sufficient in most cases.

All references referred to above are hereby incorporated by reference.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the scope of the present disclosure, and that they may make various changes, substitutions and alterations herein without departing from such scope.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. A sensor for monitoring a hydrate inhibitor dissolved in a liquid, the sensor comprising:
an internal reflection window configured to contact the liquid;
a mid-infrared light source configured to direct a beam of mid-infrared radiation into said window to provide for attenuated internal reflection at an interface between the window and the liquid;
a first narrow bandpass filter configured to preferentially transmit mid-infrared radiation over a band of wavelengths corresponding to an absorbance peak of the dissolved hydrate inhibitor to provide for filtering internally reflected mid-infrared radiation received from the window;
an infrared detector configured to detect the filtered mid-infrared radiation transmitted through the first filter; and
a processor arrangement operably coupled to the infrared detector and configured to measure intensity of the detected mid-infrared radiation transmitted through the first filter and determine an amount of the hydrate inhibitor dissolved in the liquid from the measured intensity.

21. A sensor according to claim 20, wherein the first narrow bandpass filter is configured to preferentially transmit mid-infrared radiation over at least one of a band of wavelengths corresponding to: a 1040 cm⁻¹ absorbance peak for monoethylene glycol; a 1084 cm⁻¹ absorbance peak for monoethylene glycol; a 1020 cm⁻absorbance peak for methanol; a 1045 cm⁻¹ absorbance peak for ethanol; a 1085 cm⁻¹ absorbance peak for ethanol; and a 1295 cm⁻¹ absorbance peak for polyvinylpyrrolidone.

22. A sensor according to claim 20, further comprising:
a second narrow bandpass filter configured to transmit mid-infrared radiation over a band of wavelengths corresponding to a reference portion of the absorbance spectrum of the liquid.

23. A sensor according to claim 22, further comprising:
a further infrared detector configured to detect filtered mid-infrared radiation transmitted through the second filter, wherein the processor arrangement is configured to measure a reference intensity of the detected mid-infrared radiation transmitted through the second filter and use the measured reference intensity in the determination of the amount of the hydrate inhibitor in the liquid.

24. A sensor according to claim 20, wherein the first narrow bandpass filter comprises a plurality of the first narrow bandpass filters each configured to transmit mid-infrared radiation over a band of wavelengths corresponding to an absorbance peak of a respective hydrate inhibitor, and wherein the or a respective further infrared detector is configured to detect the filtered mid-infrared radiation transmitted through each of the plurality of the first narrow bandpass filters and the processor arrangement is configured to measure intensity of the detected mid-infrared radiation transmitted through each first narrow bandpass filter and determine therefrom an amount of each hydrate inhibitor in the liquid.

25. A sensor according to claim 23, wherein the determined amounts of the hydrate inhibitor in the liquid is in the form of a ratio of the concentrations of the hydrate inhibitors.

26. A sensor according to claim 20, wherein the beam of mid-infrared light is pulsed.

27. A sensor according to claim 20, wherein the window comprises one of a diamond window or a sapphire window.

28. A sensor according to claim 20, further comprising a heater configured to heat the window.

29. A sensor according to claim 20, further comprising a pressure pulse arrangement configured to produce a pressure pulse in the liquid at the window to clean a surface of the window in contact with the liquid.

30. A sensor according to claim 20, wherein the sensor is located subsea.

31. A method of monitoring a hydrate inhibitor dissolved in a liquid, the method comprising:
providing a sensor, wherein the sensor comprises:
an internal reflection window configured to contact the liquid;
a mid-infrared light source configured to direct a beam of mid-infrared radiation into said window to provide for attenuated internal reflection at an interface between the window and the liquid;
a first narrow bandpass filter configured to preferentially transmit mid-infrared radiation over a band of wavelengths corresponding to an absorbance peak of the dissolved hydrate inhibitor to provide for filtering internally reflected mid-infrared radiation received from the window;
an infrared detector configured to detect the filtered mid-infrared radiation transmitted through the first filter; and
a processor arrangement operably coupled to the infrared detector and configured to measure intensity of the detected mid-infrared radiation transmitted through the first filter and determine an amount of the hydrate inhibitor dissolved in the liquid from the measured intensity, wherein the internal reflection window is in direct contact with the liquid; and
operating the sensor to determine an amount of the hydrate inhibitor dissolved in the liquid.

32. A well or pipeline tool including the sensor of claim 31.

33. A tool according to claim 32, comprising: an outer casing, wherein the internal reflection window is flush with the outer casing such that the attenuated internal reflection at the interface between the window and the liquid produces an evanescent wave which propagates into the liquid away from the tool.

34. A method for monitoring a hydrate inhibitor dissolved in a liquid, comprising:
directing a beam of mid-infrared radiation into an internal reflection window that is in contact with the liquid;
passing an attenuated internal reflection of the beam from an interface between the window and the liquid through a narrow bandpass filter configured to preferentially transmit mid-infrared radiation over a band of wavelengths corresponding to an absorbance peak of the dissolved hydrate inhibitor;
detecting the filtered mid-infrared radiation transmitted through the narrow bandpass filter;
measuring an intensity of the detected mid-infrared radiation transmitted through the narrow bandpass filter; and
determining an amount of the hydrate inhibitor dissolved in the liquid from the measured intensity.

35. A method according to claim 34, wherein the narrow bandpass filter is configured to preferentially transmit mid-infrared radiation over at least one of a band of wavelengths corresponding to: a 1040 cm⁻¹ absorbance peak for monoethylene glycol; a 1084 cm⁻¹ absorbance peak for monoethylene glycol; a 1020 cm⁻¹ absorbance peak for methanol; a 1045 cm⁻¹ absorbance peak for ethanol; a 1085 cm⁻¹ absorbance peak for ethanol; and a 1295 cm⁻¹ absorbance peak for polyvinylpyrrolidone.

36. A method according to claim 35, further comprising:
passing the attenuated internal reflection of the beam from the interface between the window and the liquid through a reference narrow bandpass filter configured to transmit mid-infrared radiation over a band of wavelengths corresponding to a reference portion of the absorbance spectrum of the liquid.

37. A method according to claim 36, further comprising:
detecting a portion of the attenuated internal reflection of the beam from the interface between the window and the liquid transmitted through the reference filter;
measuring a reference intensity of the portion of the attenuated internal reflection of the beam from the interface between the window and the liquid transmitted through the reference filter; and
using the measured reference intensity in the determination of the amount of the hydrate inhibitor in the liquid.
